(19) United States
(12) Patent Application Publication
(10) Pub. No.: US 2014/0315402 A1
(43) Pub. Date: Oct. 23, 2014

(54) Insert for Filling Grounding Contact in Standard 3-Prong Electrical Receptacle

(71) Applicant: Christopher Michael Poniktera, Emmaus, PA (US)

(72) Inventor: Christopher Michael Poniktera, Emmaus, PA (US)

(21) Appl. No.: 14/256,975

(22) Filed: Apr. 20, 2014

Related U.S. Application Data
(60) Provisional application No. 61/815,167, filed on Apr. 23, 2013.

(51) Int. Cl. H01R 13/443

(52) U.S. Cl. CPC H01R 13/443
USPC 439/148

(57) ABSTRACT

A plastic formed insert or peg is provided to block the ground connection aperture of a standard 3-prong electrical receptacle to render the receptacle usable only as a 2-prong receptacle to cure faulty or missing ground connections for the receptacle.

### BACKGROUND OF THE INVENTION

The present invention is to be utilized to conform a mistakenly installed 3-prong electrical outlet or receptacle that does not have a third wire ground connection in order to meet the electrical building code requirements for a non-grounded outlet.

In the event that a 3-prong single or duplex electrical outlet or receptacle is installed in a residence or business location where the supply wiring does not support the grounding contact in the outlet, the outlet must be replaced with a non-grounding single or duplex outlet in order to meet electrical building codes. The substitution of a non-ground outlet for the grounded outlet causes additional work by removing the unpermitted 3-prong outlet and substituting the non-grounded outlet into the electrical box. In some instances, if the wiring is old and the wires are brittle, the original wiring breaks off leaving a shortened wire that will no longer reach the connections on the substituted outlet. In this event, the electrical box must be relocated along the wall to a position suitable for the wiring to be able to reach the outlet connections. A new outlet box hole must be made, a substitute electrical box installed and the wiring positioned through that box to the substituted 2-prong outlet. The substitution of the outlet takes a significant amount of time and, if the electrical box must be relocated, the time required multiplies by the need to make a new hole in the wall at an appropriate location, the installation of a replacement electrical box and substitute outlet, and the closure of the existing hole by either the installation of a blank plate or the removal of the old electrical box and the patching of the hole.

The problem usually comes about when an unskilled worker or a home owner believes that a 3-prong grounded receptacle or outlet (either single or duplex) makes the residence or commercial space more appealing to a new occupant. However, 3-prong electrical receptacles must have a working ground connection to meet standard building electrical codes. If an electrical outlet showing a 3-prong arrangement is tested and fails to indicate a ground wire connection is present, the electrical inspector will fail the premises and require replacement of the inappropriately wired electrical fixture. This will usually require the replacement of the offending 3-prong outlet by substituting a 2-prong non-grounding electrical receptacle in its place. But, the previously described problem can more often than not occur as knob and tube or other 2-wire systems are discovered to be pre-positioned in the walls of the structure with no ability to feed another multi-conductor wire, including a ground wire, to the location. There is no present known method that allows someone to convert electrical outlets from a 3-prong receptacle array to a 2-prong electrical array and meet the requirements of the standard electrical building codes.

It is, therefore, one object of the present invention to provide a means for blocking off the grounding opening of a 3-prong grounding electrical outlet that has been improperly installed in a structure without the need for replacing the electrical outlet with the concomitant problems. It is also an object of the present invention to provide a means for blocking off the grounding opening of a 3-prong grounding electrical outlet that has been improperly installed in a structure that will meet the current standard electrical building codes. It is a further object of the present invention that, by utilizing the present invention to block off the grounding opening of a 3-prong grounding electrical outlet that has been improperly installed in a structure to save both time and expense by installing only a blocking insert into the grounding opening, securely blocking off that opening, so that it cannot be used by an occupant of the structure. It is yet an additional object of the present invention to permit an unskilled person, e.g., a homeowner, to make the necessary alteration to meet the standard electrical building codes. And finally, it is an object of the present invention to provide a means for inserting a non-removable plug to eliminate the grounding outlet in a 3-prong electrical receptacle that does not have a working ground due to deficiencies in the existing wiring allowing the receptacle to become a 2-prong non-grounding receptacle without having to actually replace the receptacle.

Other objects will appear hereinafter.

### SUMMARY OF THE INVENTION

In accordance with standard electrical building codes, 3-prong electrical receptacles must have a working ground connection or must be changed to a 2-prong electrical receptacle. The present invention solves the mandatory replacement problem by inserting a non-removable plastic peg to eliminate the ground prong aperture in a standard 3-prong electrical receptacle lacking a working ground connection. This will permit the receptacle to become a 2-prong receptacle without actually replacing the receptacle. Prior to and without the present invention one would have to change the entire receptacle which can be very costly for many reasons including disturbing and breaking old wiring that otherwise would have been fine and or hiring an electrician to replace the receptacle, and possibly replace the electrical box, and recheck the wiring.

The subject invention is an insertable peg that is configured to be lodged within a ground connection aperture of a 3-prong electrical receptacle having two parallel electrical current carrying slots and an offset ground connection capable of receiving a substantially cylindrical ground pin of a 3-prong electrical plug. The insertable peg has an elongate body and a flared head at its proximal end capable of being captured by the opposing paired metal contacts contained within the ground connection aperture of the 3-prong receptacle and then retained within the ground connection aperture by the paired metal contacts pressing inward against the elongate body of the insertable peg such that the flared head of the insertable peg entirely eliminates the ground connection aperture and creates a substantially uniform surface with the outer face of the 3-prong receptacle. The elongate body of the insertable peg is substantially cylindrical with one segment of the outer surface of the rounded elongate body being flattened to align with a corresponding ground connection aperture of the 3-prong electrical receptacle. Also, the elongate body of the insertable peg tapers slightly as it extends towards its distal end to be better accommodated between the opposing paired metal contacts contained within the ground connection. The flared head of the insertable peg mates with a depressed rim space of the ground connection aperture of the 3-prong receptacle.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is an exploded view of the blocking insert of the present invention and a 3-prong duplex grounded outlet with outlet cover positioned for insertion into the upper 3-prong grounded outlet with a second blocking insert shown inserted into the lower 3-prong grounded outlet.

FIG. 2 is a partial cut-away front view of a 3-prong duplex grounded outlet showing the internal structure of the upper 3-prong grounded outlet including the ground connection for an insertable 3-prong electrical plug.

FIG. 3 is a top view of the blocking insert of the present invention.

FIG. 4 is a sectional view of the blocking insert of the present invention taken along Line 4-4 of FIG. 3.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

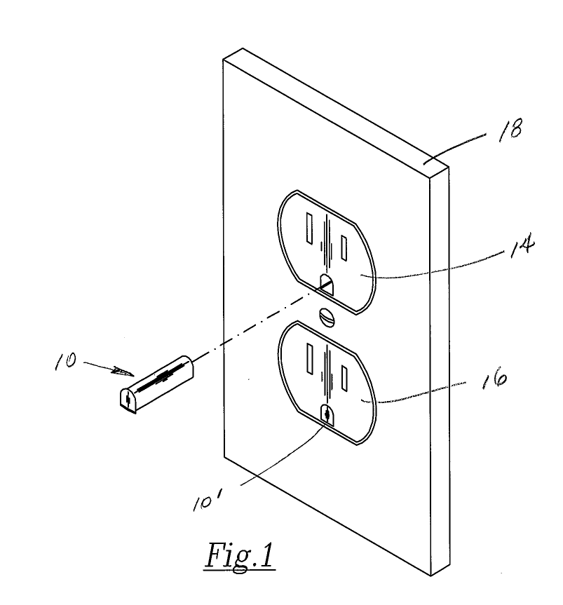

Referring now to the drawings in detail, where like numerals refer to like parts or elements, there is shown in FIG. 1 an exploded view the peg or blocking insert 10 of the present invention and a 3-prong duplex grounded outlet 12 including upper and lower 3-prong grounded outlets 14, 16 partially covered by outlet cover 18. The peg or blocking insert 10 is positioned for insertion into the upper 3-prong grounded outlet 14 with a second peg or blocking insert 10′ shown already inserted into the lower 3-prong grounded outlet 16. As shown in FIG. 1, the blocking insert 10′ fits totally within the ground connection aperture for the 3-prong plug with the top of the blocking insert 10′ being flush with the surface of the 3-prong grounded outlet 16.

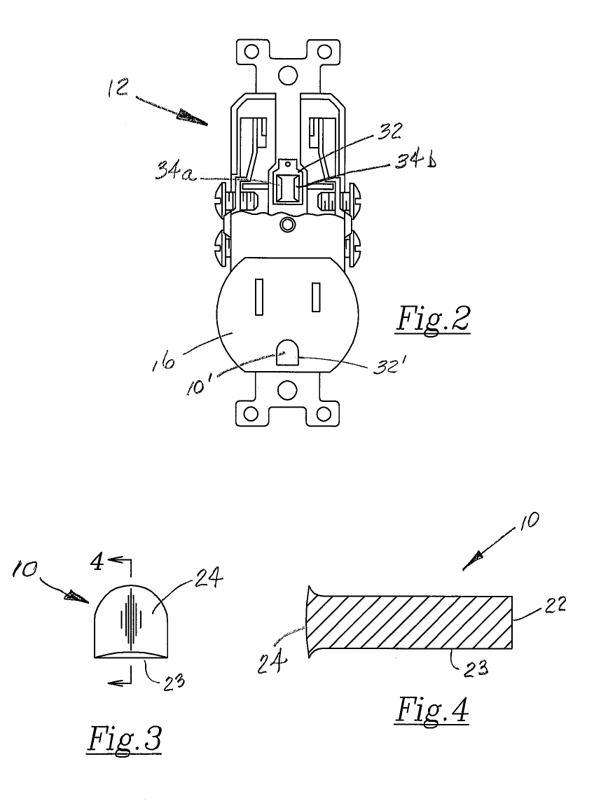

Referring to FIGS. 3 and 4, the peg or blocking insert 10 is substantially configured in a cylindrical shape having an elongate section 22 with a flared head 24 at one end. One side of the substantially cylindrical elongate section 22 is flattened to conform to the shape of the grounding aperture in the 3-prong receptacle. The flattened side 23 is shown in FIG. 3, but the flared head 24 still extends radially outward beyond the elongate section 22. The peg or blocking insert 10 is approximately 0.75 inches long including both the elongate section 22 and the flared head 24 which has a slightly arcuate top portion having a radius approximating 0.875 inches. The diameter of the cylindrical portion of the elongate section 22 is approximately 0.25 inches which is decreased along the flattened side 23 to approximately 0.2 inches. The flared head 24 extends beyond the nominal diameter of the elongate section 22, also extending outward over the flattened section 23, an approximate distance of 0.05 inches. The peg or blocking insert 10 also tapers inward from the flared head 24 along the length of the elongated section 22 in the range of a 1° decrease in diameter allowing for additional ease in inserting the blocking insert 10 into the ground connection of the 3-prong plug.

With reference to FIG. 2, the peg or blocking insert 10, with the dimensional configuration described above, will fit snugly within the ground connection 32 of the upper 3-prong receptacle 14 of duplex outlet 12. The peg or blocking insert 10 is oriented with the matching flattened side 23 of the elongate section 22 facing downward to correspond to the flat side of the ground connection aperture of the 3-prong plug as shown by the ground aperture 32′ of the lower 3-prong receptacle 16. In the ground aperture 32 of the upper 3-prong receptacle 14 are a pair of facing metal contacts 34a, 34b that exert an inward force against any article that displaces them outwards from their rest position. In addition, these metal contacts 34a, 34b are bent outward at their proximal ends to facilitate the proper positioning of the ground pin of a grounded plug. In this case, the metal contacts 34a, 34b move outward to accommodate the peg or blocking insert 10 as it is pushed into the ground connection aperture 32 and between the paired metal contacts forcing those contacts apart. The flared head 24 of the peg or blocking insert 10 is configured to approximate the shape of the outer edge or rim of the ground connection aperture 32 that is slightly recessed inward so as to fit snugly against that outer edge without any space therebetween. In this manner, when the peg or blocking insert 10 is fully inserted into the ground connection aperture 32 the outer surface of the flared head 24 creates a substantially smooth uniform surface along the outer face of the upper 3-prong receptacle 14. Without any element of the peg or blocking insert 10 remaining exposed with the capacity to grab onto by using manual dexterity or with the aid of tools, the peg or blocking insert 10 is permanently positioned creating a plugging of the ground connection aperture 32 of the upper 3-prong receptacle 14. Thus, the peg or blocking insert 10, once inserted into the ground pin aperture 32 of the 3-prong receptacle 12, permanently plugs that aperture and converts a non-conforming ungrounded 3-prong receptacle into a 2 prong electrical receptacle that is not capable of accepting a 3-prong plug having a ground pin connector causing a potentially unsafe condition.

The peg or blocking insert 10 can be manufactured by a plastics injection molding process with the resulting insert being sufficiently resilient to slightly deform as it is press-fitted into the ground connection aperture 32. The prongs 34a, 34b bend slightly outward as the peg or insert 10 is pushed between them and then spring back to clamp the insert 10 in position with the flared head 24 of the insert 10 flush with the face of the 3-prong receptacle 14 or 16. In this manner the ground connection aperture 32 or 32′ is completely filled and blocked off by the peg or blocking insert 10 so that the aperture disappears except upon close up inspection. With the peg or blocking insert 10 positioned within the ground connection aperture 32, 32′, the 3-prong receptacle 14, 16 is rendered inoperable for a 3-prong grounded plug and only 2-prong plugs can be accepted by the physically altered receptacles 14, 16.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. An insertable peg configured to be lodged within a ground connection aperture of a 3-prong electrical receptacle having two parallel electrical current carrying slots and an offset ground connection capable of receiving a substantially cylindrical ground pin of a 3-prong electrical plug, said insertable peg having an elongate body and a flared head at its proximal end capable of being captured by opposing paired metal contacts contained within the ground connection aperture of the 3-prong receptacle and retained within said ground connection aperture by said paired metal contacts such that the flared head of the insertable peg entirely eliminates the ground connection aperture and creates a substantially uniform surface with the outer face of the 3-prong receptacle.

2. The insertable peg of claim 1, wherein the elongate body of the insertable peg being substantially cylindrical with one segment of the outer surface of the rounded elongate body being flattened to align with a corresponding ground connection aperture of the 3-prong electrical receptacle.

3. The insertable peg of claim 1, wherein the elongate body of the insertable peg tapers slightly as it extends towards its distal end to be accommodated between the opposing paired metal contacts contained within the ground connection.

4. The insertable peg of claim 1, wherein the flared head of the insertable peg mates with a depressed rim space of the ground connection aperture of the 3-prong receptacle.
